(19) United States
(12) Patent Application Publication
(10) Pub. No.: US 2026/0091544 A1
(43) Pub. Date: Apr. 2, 2026

(54) MELT COOLER, INSTALLATION FOR MOULDING PLASTICS AND METHOD FOR COOLING A MELT

(71) Applicant: Reifenhäuser GmbH & Co. KG Maschinenfabrik, Troisdorf (DE)

(72) Inventors: Christoph LETTOWSKY, Aachen (DE); Peter FISCHER, Bonn (DE); Stephan SCHMITT, Eitorf (DE); Maximilian HERCHENBACH, Remagen (DE)

(21) Appl. No.: 19/110,613

(22) PCT Filed: Sep. 19, 2023
(86) PCT No.: PCT/EP2023/075749

§ 371 Date: Mar. 11, 2025

(30) Foreign Application Priority Data
Oct. 18, 2022 (DE) 10 2022 127 360.1

(51) Int. Cl. B29C 48/88; B29C 48/885; B29C 48/89; B29C 48/90

(52) U.S. Cl. CPC B29C 48/912; B29C 48/885; B29C 48/89; B29C 48/902; B29C 48/903

(57) ABSTRACT

A melt cooler for a blown-film installation with a film-tube guide, wherein the film-tube guide has a central passage for a film tube that passes through the melt cooler during the operation of the blown-film installation, wherein the melt cooler has a cooling-fluid guide, which is designed to deliver cooling fluid introduced into the cooling-fluid guide to the film tube that passes through the melt cooler during the operation of the blown-film installation, wherein the cooling-fluid guide has a manifold, which has a cooling fluid outlet for delivering the fluid, and the cooling fluid outlet delivers the cooling fluid to the passage. An installation for moulding plastics, especially a blown-film installation or flat-film installation or some other installation designed for producing a film web, with a treatment section, and a melt cooler. A method for cooling a melt of a film tube of a blown-film installation with a melt cooler.

### CROSS REFERENCE TO RELATED PATENT APPLICATIONS

This is a U.S. national phase patent application of PCT/EP2023/075749 filed Sep. 19, 2023, which claims the benefit of and priority to German Patent Application No. 10 2022 127 360.1, filed on Oct. 18, 2022, the entire contents of each of which are incorporated herein by reference for all purposes.

### TECHNICAL FIELD

The invention relates to a melt cooler, an installation for moulding plastics and a method for cooling a melt.

More precisely, the invention relates to melt coolers for a blown-film installation with a film-tube guide, wherein the film-tube guide has a central passage for a film tube that passes through the melt cooler during the operation of the blown-film installation. Further, the invention relates to an installation for moulding plastics, especially a blown-film installation or flat-film installation or some other installation designed for producing a film web with a treatment section, wherein the treatment section has a melt cooler. Furthermore, the invention relates to a method for cooling a melt of a film tube of a blown-film installation with a melt cooler.

### BACKGROUND

Blown-film installations are known and proven in the prior art: plastic granulate is melted in an extruder and fed via a pre-distribution to a blowing head having a spiral manifold. The melt passes via the spiral into an annular gap which opens into a ring slit nozzle. The melt is extruded from the ring slit nozzle as a film tube. Via an increased internal pressure in the film tube, the film tube widens in a so-called tube formation zone immediately after exiting the ring slit nozzle and often a subsequent cooling ring, which stretches the film in particular transversely to the machine direction. The film is subsequently cooled down, calibrated, flattened and subsequently, as a general rule, redirected and wound. At the take-off unit, beyond a frost line, calibration and flattening, a pair of squeezing rollers is usually provided, wherein at least one roller is driven and the circumferential speed of the roller is greater than the exit speed of the molten tube at the ring slit nozzle. As a result, the film tube is additionally stretched lengthwise.

Beyond the take-off unit there is normally a reversing device with turning bars. In the reversing device, the turning bars rotate cyclically around the vertical axis before the film web is finally fed to a winding station and is wound there to produce a film roll.

Due to the process, the produced film tube most commonly has a thickness profile which is not perfectly uniform across the circumference.

The film tube arrives at the take-off unit in an already solidified state. For this purpose, the film tube must be cooled down after it exits the ring slit nozzle.

A wide variety of means can be deployed to cool down the film tube.

Cooling rings have proven to be very effective. In general, a cooling ring is located directly on, but in any event at least close to, the ring slit nozzle in order to be able to act on the melt which is as hot as possible. Most cooling rings are stationary, wherein a cooling ring can also be advantageously adjusted in its height.

A cooling ring is arranged around the outside of the film tube and has a circular passage for the film tube in its interior. Cooling air is blown into the cooling ring from the outside and exits inwards via a cooling-air nozzle onto the film tube as it passes through. A cooling ring is also a tried-and-tested means of influencing the cooling properties of the film tube: the cooling-air temperature can be changed in this way. In the case of some cooling rings there are even small mechanical control actuators in the interior of the cooling-air guide, which influence the air flow of the blown-in cooling air so that it can be distributed over the circumference of the cooling ring and the cooling air can be directed in a non-uniform manner from the cooling ring or, respectively from the cooling-air nozzle onto the film tube. As a result, irregularities in the thickness of the film tube along the circumference can be eliminated.

### SUMMARY

Since, at the current time, the applicant of the present patent application usually constructs its installations for extrusion in a vertical direction with gravity, reference will be made, first and foremost, to this orientation in the text below. However, it is expressly pointed out that the invention can also be applied to all of the remaining spatial directions. The person skilled in the art will be able to adjust the features disclosed here analogously if necessary.

It is true that the reversing device ensures that a non-uniformity in the film thickness does not show up as a singular excessively thickened location in the film roll. Nevertheless, it is desirable to improve the uniformity in the film thickness for some film products.

Extrusion with gravity creates possibilities for cooling down the film tube, which do not arise during extrusion against gravity, that is to say upwards. Thus, it is for example possible that the film tube is cooled with water. To this end, the film tube is inflated with air after the ring slit nozzle and guided through a bushing, via which the film tube is calibrated and therefore defined in its circumference. Thanks to the described increased internal pressure in the film tube, the film tube widens in said tube formation zone and comes to bear against the inner wall of the bushing. As a general rule, such a bushing is also flowed through by cooling water in addition to the film tube. As a general rule, the cooling water is arranged between the film tube and the bushing; it prevents the film tube from bonding to the lateral surface of the bushing. At the end or immediately after the bushing, the cooling water is sucked off again so that the film tube can be further transported along the film-tube guide in a relatively dry condition.

According to a first aspect, the formulated object is achieved by a melt cooler for a blown-film installation. The blown-film installation has a film-tube guide, wherein the film-tube guide has a central passage for a film tube that passes through the melt cooler during the operation of the blown-film installation. The melt cooler has a cooling-fluid guide, which is designed to deliver cooling fluid introduced into the cooling-fluid guide to the film tube that passes through the melt cooler during the operation of the blown-film installation. The cooling-fluid guide has a manifold, which has a cooling fluid outlet for delivering the fluid. The cooling fluid outlet delivers the cooling fluid to the passage.

Conceptually, the following is explained:
It is expressly pointed out that within the framework of the present patent application, indefinite articles and indefinite numerals such as “one . . . ”, “two . . . ”, etc. are normally to be understood as indicating a minimum, that is to say, “at least one . . . ”, “at least two . . . ”, etc., unless it is clear from the context or the specific text of a particular passage that only “exactly one . . . ”, “exactly two . . . ” , etc. are intended. Furthermore, all numerals and all information on method parameters and/or device parameters are to be understood in the technical sense, i.e., taking into account the usual tolerances. Even if the restrictive wordings “at least” or the like are explicitly indicated, this does not mean that if it simply says “one”, that is to say without the use of “at least”or the like, “exactly one”is intended.

A film-tube guide is understood to be the part of the blown-film installation, which lies between a blowing head, from which the initially viscous plastic melt exits as a film tube, and a winder, which ultimately winds the film web which has hardened up to that point, been flattened into a double film web and possibly been further processed.

The melt cooler is preferably provided for arrangement in a tube formation zone. The tube formation zone is the region between a ring slit nozzle, from which melt is extruded as a film tube and is subsequently widened via an increased internal pressure in the film tube. A cooling ring following the ring slit nozzle is often present, which cools the film tube from the outside. In the tube formation zone, the film tube is stretched, in particular transversely to the machine direction. The film is subsequently calibrated, that is to say is brought to the desired size in its outer circumference.

It is in particular preferred that the melt cooler is provided for positioning inside the tube formation zone between the ring slit nozzle and the calibration of the film tube.

The cooling-fluid guide preferably has at least one connection for the cooling fluid. The cooling-fluid guide is preferably configured for uniform distribution of the cooling fluid. To this end, channels can be provided, for example, which are adjusted in their cross-section in such a way that a uniform delivery of the cooling fluid is made possible. The cooling fluid outlet makes possible delivery of the cooling fluid. The cooling fluid outlet is preferably formed by a plurality of openings from which the cooling fluid exits. The cooling fluid is preferably delivered directly in the direction of the passage. For example, diaphragms or lips can be provided, which direct the cooling fluid in a specific direction. It could be provided by such directing elements that the cooling fluid is diverted upwards or downwards after it hits the film tube. The manifold is preferably configured in such a way that a cushion is formed by the exiting cooling fluid so that the film tube running past can pass the melt cooler without contact. It can be ensured by such a cushion that a surface of the film tube is not damaged.

In one embodiment of the first aspect of the invention, the melt cooler has a frame which is configured to receive the manifold.

Assembly and/or dismantling of the melt cooler is/are particularly easy thanks to a design with a frame which receives the manifold.

Assembly and/or dismantling take(s) place, for example, when the melt cooler is to be cleaned. To this end, the manifold can be removed from the frame and freed of monomer residues and other residues, for example. It is also conceivable for the cleaning that a cleaning fluid flows through the melt cooler instead of a cooling fluid. Such cleaning preferably does not take place during the operation of the blown-film installation. The frame can be configured in multiple parts and can receive the manifold between these parts. The frame can comprise the cooling-fluid guide which can be arranged, for example, in a recess behind the manifold. Sealing elements can be provided between the frame and the manifold, which prevent the cooling fluid from exiting at undesirable locations.

In one embodiment of the melt cooler, the melt cooler is configured as a ring which is arranged around the film tube.

Thanks to the design of the melt cooler as a ring, it is particularly advantageous to arrange said melt cooler in the tube formation zone around the film tube. Since the film tube which is formed is, as a general rule, circular, a melt cooler configured as a ring is particularly suitable for uniform cooling.

In one embodiment of the melt cooler, the melt cooler is configured as a ring which is arranged inside the film tube.

The melt cooler can be provided for arrangement inside the film tube. In the case of this design as well, it is advantageous if the melt cooler is configured as a ring.

In one embodiment, the melt cooler can have both an inner and an outer manifold, so that the film tube is cooled by the melt cooler from both sides, that is to say, from the inside and the outside. The inner melt cooler can, for example, be mounted centrally on the annular nozzle. An inner melt cooler is preferably movable between a start-up position and an operating position, so that starting up the blown-film installation is made easier.

In one embodiment of the melt cooler, the cooling fluid outlet has pores, through which the cooling fluid can be delivered.

The manifold is preferably open-pored. Thanks to an open-pored configuration, the cooling fluid can be delivered through the pores. In this case, the porosity is a dimensionless measured variable and represents the ratio of the cavity volume to the total volume of a substance or mixture of substances. It serves as a classifying measure for the cavities actually present. The variable is applied in the field of materials and structural engineering. The porosity has a large influence on the density of a material as well as on the resistance when flowing through a bed (Darcy's law). Originally caused by natural conditions and, as a general rule, undesirable particularly during the production of sophisticated cast products, there is now also a porosity which is brought about artificially and which is, in this respect, desirable. The manifold is preferably a porous metal foam, in particular it is preferably an aluminium foam.

The manifold preferably has a density of 1 to 3 g/cm3, in particular the manifold preferably has a density of 1.8 g/cm3.

The manifold preferably has a Shore D hardness in accordance with DIN EN ISO 868 of 75 to 95, in particular, the manifold preferably has a Shore D hardness of 85.

The manifold preferably has a DIN EN ISO 527 E-modulus of 5000 N/mm2 to 7000 N/mm2, in particular the manifold preferably has an E-modulus of 6000 N/mm2 to 6200 N/mm2.

The manifold preferably has a compressive strength in accordance with DIN EN ISO 604 of 25 to 36, in particular, the manifold preferably has a compressive strength of 29 to 33.

A total porosity of the manifold is preferably between 5% and 45%. The total porosity is particularly preferably between 15% and 25%.

In one embodiment of the melt cooler, the pores are pores which have an average pore diameter of less than 50 μm. The manifold preferably has an average pore diameter between 2 μm and 50 μm. The average pore diameter is particularly preferably between 8 μm and 18 μm.

In one embodiment of the melt cooler, the manifold has multiple segments. The manifold is preferably composed of the multiple segments.

A segmented construction of the manifold is in particular advantageous during cleaning, since this makes it possible for individual segments to be cleaned consecutively. Consequently, a cleaning device for the manifold can have smaller dimensions. Furthermore, the production of a segmented manifold can be more favourable. In the event of a defect on one surface of the manifold, it is possible to merely replace an individual segment thanks to a segmented construction. Thanks to the segmented construction, it is not necessary to replace the entire manifold if one segment of the manifold is damaged.

The individual segments can be bonded with one another, for example. For cleaning purposes, it is preferred that such bonds are configured in a detachable manner. To avoid visible residues from bonds or adjacent segment edges, the segment edges between the segments can run diagonally, for example, instead of simply running vertically. Thanks to such a diagonal profile, the influence of such segment edges or bonding on a film surface of the film tube is minimized.

In one embodiment of the melt cooler, the melt cooler is configured in such a way that the cooling fluid is delivered in the direction of travel of the film tube.

Thanks to this design, the cooling fluid can be utilized particularly efficiently, since it does not escape into regions in which it does not have any cooling effect or respectively does not escape into a region in which it has a reduced cooling effect.

In one embodiment of the melt cooler, the melt cooler has an actuator for mechanically adjusting a volume flow of the cooling fluid during operation.

Thanks to such a design with an actuator for mechanically adjusting the volume flow, the cooling fluid can be selectively delivered to individual regions of a surface of the film tube. By selectively delivering the cooling fluid to the surface of the film tube, flatness imperfections on the surface of the film tube can be compensated for particularly precisely. In connection with this, it is preferred that the blown-film installation has a means for detecting flatness imperfections on the surface of the film tube. This can be arranged both in front of the melt cooler or behind the melt cooler in the production direction. If it is arranged behind the melt cooler, it requires a preferably automatic assignment of flatness imperfections on the surface of the film tube to a corresponding position on the melt cooler.

In one embodiment of the melt cooler, the cooling fluid outlet has a gradient based on a direction of travel of the film tube, which makes possible a defined distribution of a volume flow of the cooling fluid.

It can be preferred that the cooling fluid outlet delivers different quantities of cooling fluid to the film tube based on the direction of travel of the film tube. A particularly gentle cooling of the melt can be achieved by the gradient, for example, by delivering a smaller quantity of cooling fluid to the film tube based on the direction of travel of the film tube thanks to the gradient at the start of the melt cooler and, thanks to the gradient, the quantity of cooling fluid increases along the direction of travel of the film tube. Conversely, it is possible to achieve a particularly rapid cooling of the film tube by initially delivering a larger quantity of cooling fluid to the film tube thanks to the gradient and reducing the quantity of cooling fluid which hits the film tube along the direction of travel of the film tube.

In one embodiment of the melt cooler, it has a tempering means via which the cooling fluid can be brought to a predefined temperature.

The tempering means can, for example, be a heating device which brings the cooling fluid to a previously defined temperature before it hits the film tube. Equally, the tempering means can also be a cooling device. It is preferred that the tempering means is coupled to sensor technology. The sensor technology is preferably configured to detect temperatures by means of one or more sensors. Such a sensor of the sensor technology can be utilized, for example, to detect the temperature of the cooling fluid before the tempering means and/or to detect the temperature of the cooling fluid after the tempering means. Furthermore, such a sensor can be utilized to detect a temperature of a surface of the film tube. It can be advantageous to detect the surface of the film tube before and after the melt cooler.

In one embodiment of the melt cooler, it has multiple manifolds arranged one above the other based on a direction of travel of the film tube. The gradient already described above can, for example, be realized in a particularly simple manner thanks to the manifolds arranged one above the other. Furthermore, more gentle cooling can be made possible by multiple manifolds arranged one above the other.

In one embodiment of the melt cooler, the melt cooler is configured to be adjustable in its position in the blown-film installation, the melt cooler is preferably horizontally movable.

The melt cooler can be transferred into a service position, for example, thanks to the adjustability. This adjustability is in particular relevant when the blown-film installation is at a standstill or when the blown-film installation is starting up. In this service position, the cleaning described above or, respectively the disassembly of the melt cooler described above can also take place, for example.

In one embodiment of the melt cooler, the melt cooler is configured to be adjustable in its position in the blown-film installation during the operation of the blown-film installation. The melt cooler is preferably configured to be adjustable in its transverse axis and/or in its longitudinal axis and/or in its height based on the direction of travel of the film tube.

The melt cooler is preferably adjustable along its vertical axis. As a result, its position with respect to the film tube can be adjusted during the operation of the blown-film installation. If it is adjustable along its longitudinal axis and/or along its transverse axis, the melt cooler can be displaced with respect to the film tube by rolling and/or pitching. Thanks to the adjustability during the operation of the blown-film installation, the melt cooler can act particularly precisely on the film tube. In this case, for example, a non-horizontally running frost line of the melt can be compensated for and/or corrected.

In one embodiment of the melt cooler, the melt cooler has an internal diameter of 200 mm to 1800 mm. The internal diameter of the melt cooler is preferably adjusted to a calibration diameter of the film tube.

The ratio of the internal diameter of the melt cooler to the calibration diameter of the film tube can be 1:1. In embodiments, the internal diameter of the melt cooler can also be undersized with a certain entry form adjustment. The internal diameter of the melt cooler can preferably be adjusted depending on the machine.

In one embodiment of the melt cooler, based on a direction of travel of the film tube, the manifold has a height of 4 mm to 200 mm. The melt cooler preferably has a height of 50 mm to 70 mm.

In one embodiment of the melt cooler, the cooling fluid outlet for delivering the fluid has an angle of 0° to 40° based on a direction of travel of the film tube, the cooling fluid outlet for delivering the fluid preferably has an angle of 1° to 10° based on the direction of travel of the film tube. The cooling fluid outlet for delivering the fluid is preferably configured tangentially to the direction of travel of the film tube based on a direction of travel of the film tube.

In one embodiment of the melt cooler, the melt cooler has a mating structure which is arranged on a surface of the film tube facing away from it.

The melt cooler is particularly preferably arranged on an exterior of the full tube. In particular, this externally arranged melt cooler is advantageous in conjunction with a calibration with water cooling, since it can lead to a smoother surface of the film tube thanks to the cooling of the surface of the film tube.

The mating structure can be configured, for example, as an internal cooling body. The mating structure is preferably arranged inside the film tube following the annular nozzle. In a particularly advantageous embodiment, the mating structure can be adjusted to a height position of the melt cooler based on the direction of travel of the film tube. Thanks to the mating structure, it can be avoided, for example, that the film tube is pushed in by the application of the cooling fluid through the melt cooler. The mating structure preferably has its own melt cooler, which is configured according to the melt cooler of the present invention and delivers a cooling fluid to the surface of the film tube.

In one embodiment of the melt cooler, the melt cooler has segmented elements which can be guided to the position of the film tube.

That is to say that the melt cooler can have multiple segmented elements which can be retracted radially. The individual segments are adjusted in such a way that they form the assembled melt cooler in one operating position.

In one embodiment of the melt cooler, the cooling fluid comprises a gas. The cooling fluid is particularly preferably air.

The air can be conveyed into the melt cooler by means of pumps and/or compressors and delivered via its pores. In embodiments, the gas can also be noble gases and/or mixtures of gaseous fluids. For cleaning purposes, a cleaning fluid can be introduced into the system instead of the cooling fluid. The cleaning fluid can, for example, comprise a solvent.

In one embodiment of the melt cooler, the melt cooler is configured for a volume flow of the cooling fluid of 0.1 l/min/cm2 to 1 l/min/cm2 at 1 bar pressure.

In one embodiment of the melt cooler, the melt cooler is configured to cool down a surface of the film tube by 0.5°to 20°Kelvin. Due to a relatively low cooling of the surface, the surface is preferably only cooled down to the extent that it has a sufficient strength so as not to be buckled in a subsequent calibration process.

In one embodiment of the melt cooler, wherein the melt cooler is configured to cool a melt surface. In this case, the melt surface of the film tube is preferably to be understood to be a layer of the film tube which is in the range of 0.1 to 4 um of a film thickness.

In one embodiment of the melt cooler, the melt cooler is provided for a blown-film installation, in which the film tube is extruded from top to bottom.

In particular, in the case of this design, the melt cooler is advantageous since the weight of the film tube pulls the film tube downwards during an extrusion directed from top to bottom. The surface of the melt can be cooled and therefore stabilized by the melt cooler, in order to allow the surface to harden largely without flatness imperfections.

In one embodiment of the melt cooler, the melt cooler is provided for arrangement before a water cooling of the film tube based on a direction of travel of the film tube.

According to a second aspect of the invention, the formulated object is achieved by an installation for moulding plastics, especially a blown-film installation or flat-film installation or some other installation designed for producing a film web with a treatment section, wherein the installation for moulding plastics has a melt cooler of the type described above on the treatment section.

In one embodiment of the second aspect of the invention, the installation for moulding plastics is configured as a blown-film installation.

In one embodiment of the second aspect of the invention, the melt cooler is arranged on the treatment section after a film blowing head. The melt cooler is preferably arranged after the film blowing head before a calibration.

In one embodiment of the second aspect of the invention, the blown-film installation is provided for extrusion of a film tube from top to bottom. That is to say that the film tube is extruded with gravity in the case of such a system, and not inflated upwards as in other installations.

In one embodiment of the second aspect of the invention, the blown-film installation has a cooling unit of the film tube, in which water is used as the cooling medium. This cooling unit is preferably combined with a calibration. The cooling unit is constructed in such a way that the film tube passes through a bushing against which the film tube comes to bear from the inside thanks to the inflation and is calibrated to a defined circumference. For simultaneous cooling, water is guided onto the film tube and through the bushing, so that the film tube is cooled and the melt at least partially hardens.

In one embodiment of the second aspect of the invention, the melt cooler is arranged on the treatment section after a film blowing head and before the cooling unit of the film tube.

According to a third aspect of the invention, the formulated object is achieved by a method for cooling a melt of a film tube of a blown-film installation with a melt cooler of the type described above. In the case of the method, the surface of the film tube is cooled by means of a cooling fluid.

In one embodiment of the third aspect of the invention, the surface of the film tube in the region of the melt cooler is cooled by 1° to 30° Kelvin.

Only the surface of the film tube is preferably cooled down and not the entire film tube. The melt cooler should preferably ensure that the surface of the film tube is hardened in such a way that it is not compressed inside the cooling unit. This ensures that the surface of the full tube remains particularly smooth.

In one embodiment of the third aspect of the invention, irregularities in a surface temperature of the film tube are compensated for by an adjustability of the melt cooler in its longitudinal and/or transverse axis and/or its height based on the direction of travel of the film tube. The irregularities in a surface of the full tube can preferably be compensated for by the already described adjustability of the melt cooler in its longitudinal, transverse and/or vertical axis.

### DESCRIPTION OF DRAWINGS

The invention is explained in greater detail below based on exemplary embodiments with reference to the drawings, wherein:

FIG. 1 shows a perspective view of a blown-film installation having a general bottom-to-top production direction;

FIG. 2 shows a perspective view of a blown-film installation having a general top-to-bottom production direction;

FIG. 3 shows a schematic sketch of a detail of a blown-film installation according to the invention having a top-to-bottom production direction from the nozzle to behind the calibration region;

FIG. 4 shows a frame of a multi-part melt cooler without a manifold;

FIG. 5 shows a manifold of a multi-part melt cooler without a frame;

FIG. 6 shows a cross-section of the manifold from FIG. 5;

FIG. 7 shows a cross-section of a multi-part melt cooler with a frame and a manifold clamped therein.

### DESCRIPTION OF AN EMBODIMENT

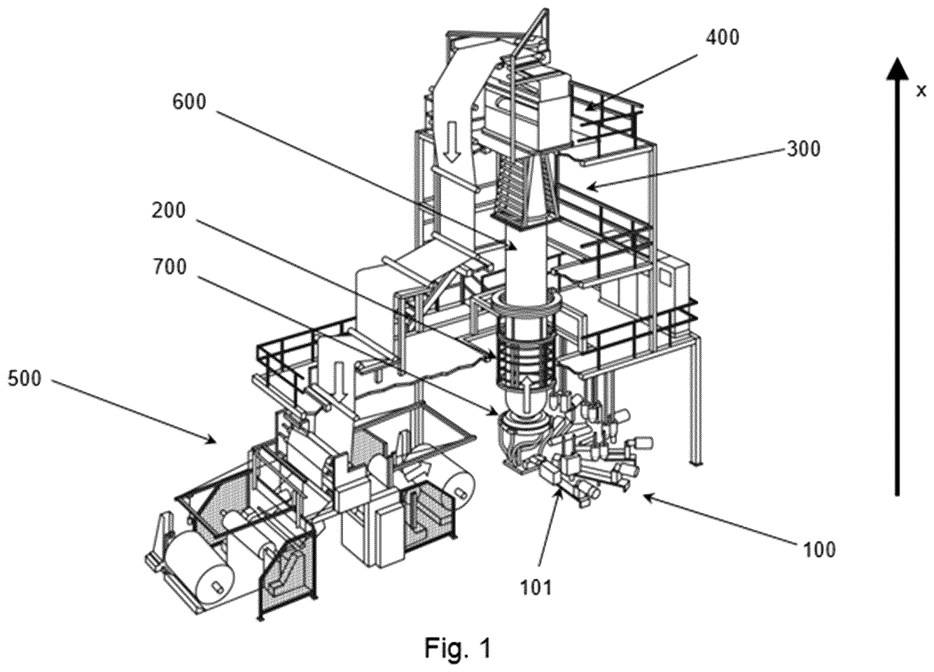

The blown-film installation shown in FIG. 1 has a general bottom-to-top production direction x. The blown-film installation has the extruder region 100 arranged at the bottom, i.e., at ground level on the floor of a production hall. Multiple extruders 101 operate on a blowing head having an annular nozzle 110 (not shown in the view). A film tube which is inflated via the annular nozzle exits from the annular nozzle 110 so that a film bubble 600 is produced from the film tube. The film tube is radially stretched by the inflation.

A cooling ring 700 follows the annular nozzle 110 in the production direction x. Various embodiments of cooling rings 700 with different numbers of lips are known. Thus, for example, cooling rings having one, two or even three cooling ring lips 704, 705 are also known. The film bubble 600 is cooled in the cooling ring 700 from the outside by cooling fluid being brought into contact with the exterior of the film bubble 600 through a cooling fluid nozzle 702, 703. A calibration region 200 in which the external diameter of the film bubble 600 is calibrated follows in the production direction x. Following the calibration region 200 in the production direction is a take-off region 300 in which the film tube is squeezed and taken off via a pair of rollers. The inflation pressure is confined in the film bubble 600 by the squeezing. When taken off, the film bubble is stretched in the axial direction so that a biaxially stretched consolidated film tube is produced behind the take-off region 300. A stretching region 400 follows the take-off region 300 in the production direction x in which the consolidated film tube is further axially stretched. Behind the stretching region the flattened film tube is redirected and guided back to the level of the extruder region 100, that is to say, at ground level on the floor of a production hall, where it is wound in a winding region 500. The general bottom-to-top production direction x is typical of blown-film installations in which the film bubble 600 is cooled with air.

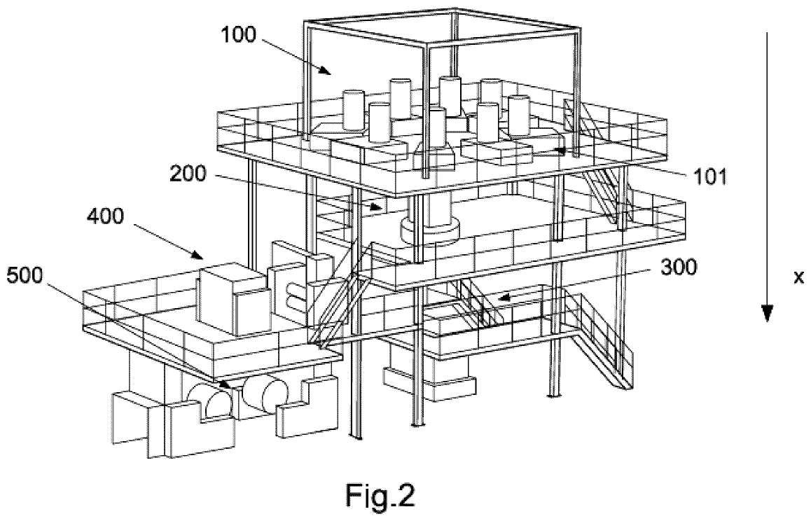

The blown-film installation shown in FIG. 2 has a general top-to-bottom production direction x. The blown-film installation has the extruder region 100 arranged at the top, i.e., above all of the other installation components. Multiple extruders 101 operate on a blowing head having an annular nozzle 110 (not shown in the view). A film tube which is inflated via the annular nozzle exits from the annular nozzle 110 so that a film bubble 600 is produced from the film tube. The film tube is radially stretched by the inflation. A cooling ring 700 follows the annular nozzle 110 in the production direction x. Various embodiments of cooling rings 700 with different numbers of lips are known. Thus, for example, cooling rings having one, two or even three cooling ring lips 704, 705 are also known. The general top-to-bottom production direction x is typical of blown-film installations in which the film bubble 600 is cooled in the cooling ring 700 with a liquid cooling fluid, for example water, since a liquid cooling fluid film which can follow gravity in this production direction x is usually applied to the film bubble 600 here. The film bubble 600 is cooled in the cooling ring 700 from the outside by cooling fluid being brought into contact with the exterior of the film bubble 600 through a cooling fluid nozzle 702, 703. A calibration region 200 in which the external diameter of the film bubble 600 is calibrated follows in the production direction x. Following the calibration region 200 in the production direction is a take-off region 300 in which the film tube is squeezed and taken off via a pair of rollers. The inflation pressure is confined in the film bubble 600 by the squeezing. When taken off, the film bubble is stretched in the axial direction so that a biaxially stretched consolidated film tube is provided behind the take-off region 300. A stretching region 400 follows the take-off region 300 in the shown embodiment in which the consolidated film tube is further axially stretched, wherein the film tube is redirected to the stretching region since, in this embodiment, for space reasons, the stretching region 400 is arranged next to but above the stretching region. Behind the stretching region, the flattened film tube is redirected and guided back to the level of the stretching region, that is to say at ground level on the floor of a production hall, where it is wound in a winding region 500.

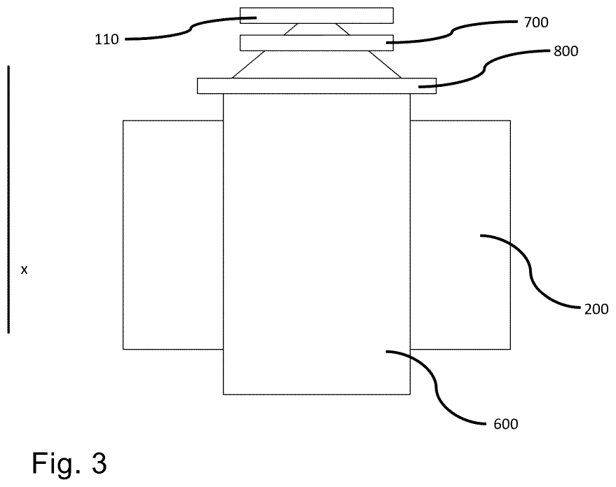

FIG. 3 shows a schematic sketch of a detail of a blown-film installation according to the invention from the nozzle 110 to behind the calibration region 200. The film tube extruded from the nozzle 110 is inflated to produce the film bubble 600 and initially passes through a cooling ring 700 in which it is cooled on the exterior with a cooling fluid by a cooling fluid being brought into contact with the exterior of the film bubble 600.

The film bubble 600 subsequently passes through the calibration region 200 in which the external diameter of the film bubble is calibrated.

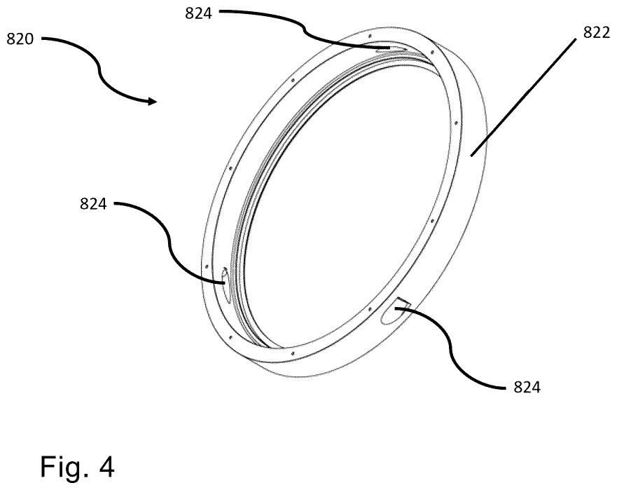

FIG. 4 shows the frame 820 of a multi-part melt cooler. The melt cooler 800 is configured as a ring in this exemplary embodiment. The melt cooler 800 is designed for air as the cooling medium. The frame 820 is illustrated without the manifold 810. The frame 820 has multiple cooling fluid inlets 824 on an outer lateral surface 822. The frame 820 is made of a stainless steel in this exemplary embodiment. The cooling fluid inlets 824 are configured for air as the cooling medium. In this exemplary embodiment, they have an inlet angle which is less than 90° relative to the radius in order to better distribute incoming air in a cooling-fluid guide.

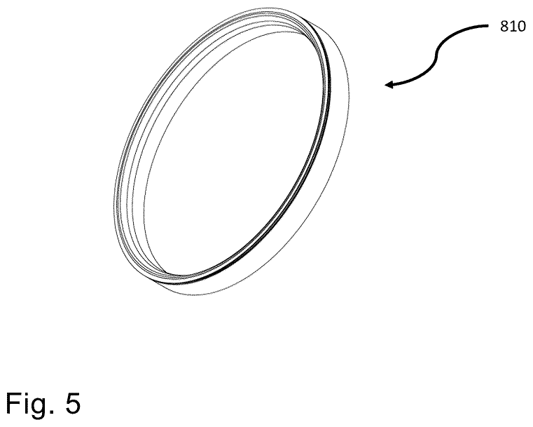

FIG. 5 shows a manifold 810 of the melt cooler 800. The manifold 810 is formed from a porous aluminium. The manifold 810 has a density of 1.8 g/cm3. The average pore diameter of the manifold 810 is 12 micrometres. The total porosity is 21%.

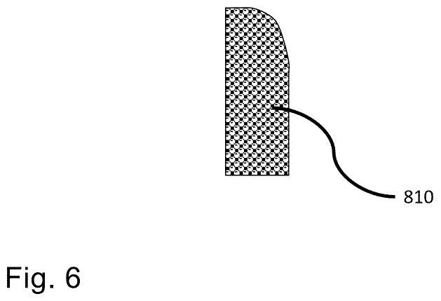

FIG. 6 shows a cross-section through the manifold 810 from FIG. 5. It can be seen that the manifold 810 has an upper inlet region 812, which forms a widened inlet for the film tube 600 during operation in a blown-film installation. Thanks to said inlet region 812, it is possible to prevent the film tube 600 from being compressed on the manifold 810 and, in the worst case, from tearing.

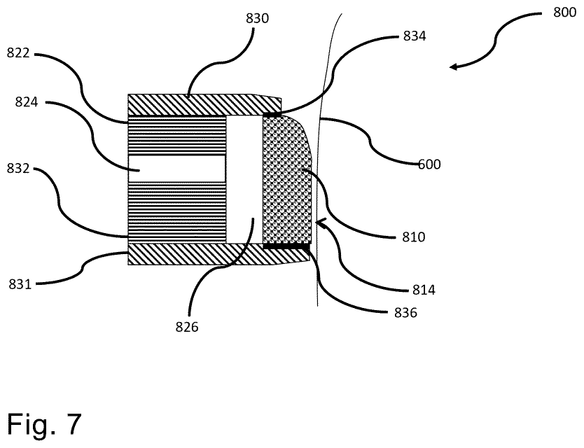

FIG. 7 shows the melt cooler 800 in cross-section in an assembled state. The manifold 810 is clamped between multiple components 830, 831 and 832 of the frame 820. In order to prevent the cooling medium from exiting between the frame 820 and the manifold 810, multiple sealing elements 834, 836 are provided between the manifold 810 and the components 830 and 832. The depicted section of the manifold 810 also shows a cooling fluid inlet 824 on the outer lateral surface 822, which is fluidically connected to a cooling-fluid guide 826. The film tube 600 slides past an air cushion 814 on the manifold 810.

The embodiments shown here only represent examples of the present invention and thus should not be construed as limiting. Alternative embodiments considered by the person skilled in the art are equally comprised within the protective scope of the present invention.

### LIST OF REFERENCE NUMERALS USED

100 Extruder region
101 Extruder
110 Annular nozzle, nozzle
200 Calibration region
300 Take-off region
400 Stretching region
500 Winding region
600 Film bubble/Film tube
700 Cooling ring, double-lip cooling ring
800 Melt cooler
810 Manifold
812 Inlet region
814 Air cushion
820 Frame
822 Lateral surface
824 Cooling fluid inlet
826 Cooling-fluid guide
830 Component of the frame
831 Component of the frame
832 Component of the frame
834 Sealing element
836 Sealing element
x Production direction

1-35. (canceled)

36. A melt cooler for a blown-film installation comprising a film-tube guide, wherein the film-tube guide has a central passage for a film tube that passes through the melt cooler during the operation of the blown-film installation, wherein the melt cooler has a cooling-fluid guide, which delivers a cooling fluid introduced into the cooling-fluid guide to the film tube that passes through the melt cooler during the operation of the blown-film installation, wherein the cooling-fluid guide has a manifold, which has a cooling fluid outlet for delivering the cooling fluid, and the cooling fluid outlet delivers the cooling fluid to the passage.

37. The melt cooler according to claim 36, wherein the melt cooler has a frame which is configured to receive the manifold.

38. The melt cooler according to claim 36, wherein the melt cooler is configured as a ring which can be arranged around the film tube.

39. The melt cooler according to claim 36, wherein the melt cooler is configured as a ring which can be arranged inside the film tube.

40. The melt cooler according to claim 36, wherein the manifold has pores as the cooling fluid outlet, through which the cooling fluid can be delivered.

41. The melt cooler according to claim 40, wherein the pores have an average pore diameter of less than 50 μm.

42. The melt cooler according to claim 36, wherein the manifold is comprised of multiple segments.

43. The melt cooler according to claim 42, wherein the individual segments are bonded with one another to form the manifold.

44. The melt cooler according to claim 36, wherein the melt cooler is configured in such a way that the cooling fluid is delivered in a direction of travel of the film tube.

45. The melt cooler according to claim 36, wherein the melt cooler has an actuator for mechanically adjusting a volume flow of the cooling fluid.

46. The melt cooler according to claim 36, wherein the cooling fluid outlet has a gradient, which makes possible a defined distribution of a volume flow of the cooling fluid, based on a direction of travel of the film tube.

47. The melt cooler according to claim 36, wherein the melt cooler has a tempering means, via which the cooling fluid can be brought to a predefined temperature.

48. The melt cooler according to claim 36, wherein the melt cooler has multiple manifolds arranged one above each other based on a direction of travel of the film tube.

49. The melt cooler according to claim 36, wherein the melt cooler is configured to be adjustable in its position in the blown-film installation.

50. The melt cooler according to claim 36, wherein the melt cooler is configured to be adjustable in its position in the blown-film installation during the operation of the blown-film installation.

51. The melt cooler according to claim 36, wherein the melt cooler has an internal diameter of 200 mm to 1800 mm or is adjusted to a calibration diameter of the film tube.

52. The melt cooler according to claim 36, wherein, based on a direction of travel of the film tube, the manifold has a height of 4 mm to 200 mm.

53. The melt cooler according to claim 36, wherein the cooling fluid outlet for delivering the cooling fluid has an angle of 0° to 40° based on a direction of travel of the film tube.

54. The melt cooler according to claim 36, wherein the melt cooler has a mating structure which is arranged on a surface of the film tube facing away from it.

55. The melt cooler according to claim 36, wherein the melt cooler has segmented elements which can be guided to the film tube.

56. The melt cooler according to claim 36, wherein the melt cooler is provided for the cooling fluid in a gaseous state.

57. The melt cooler according to claim 36, wherein the melt cooler is configured to a volume flow of the cooling fluid of 0.1 l/min/cm2 to 1 l/min/cm2 at 1 bar pressure.

58. The melt cooler according to claim 36, wherein the melt cooler is configured to cool down a surface of the film tube by 0.5° Kelvin to 20° Kelvin.

59. The melt cooler according to claim 36, wherein the melt cooler is configured to cool a melt surface.

60. The melt cooler according to claim 36, wherein the melt cooler is provided for the blown-film installation, in which the film tube is extruded from top to bottom.

61. The melt cooler according to claim 36, wherein the melt cooler is arranged before a water cooling of the film tube, based on a direction of travel of the film tube.

62. An installation for moulding plastics, especially the blown-film installation or a flat-film installation or for producing a film web with a treatment section, wherein the treatment section comprises the melt cooler according to claim 36.

63. The installation for moulding plastics according to claim 62, wherein the installation for moulding plastics is the blown-film installation.

64. The installation for moulding plastics according to claim 63, wherein the melt cooler is arranged on the treatment section after a film blowing head.

65. The installation for moulding plastics according to claim 62, wherein the blown-film installation extrudes a film tube from top to bottom.

66. The installation for moulding plastics according to claim 62, wherein the blown-film installation has a cooling unit of the film tube, in which water is used as a cooling medium.

67. The installation for moulding plastics according to claim 66, wherein the melt cooler is arranged on the treatment section after a film blowing head and before the cooling unit of the film tube.

68. A method for cooling a melt of the film tube of the blown-film installation with the melt cooler according to claim 36, wherein a surface of the film tube is cooled by the cooling fluid.

69. The method according to claim 68, wherein the surface of the film tube in a region of the melt cooler is cooled by 1° to 30° Kelvin.

70. The method according to claim 68, wherein irregularities in a surface temperature of the film tube are compensated for by an adjustability of the melt cooler in a longitudinal and/or transverse axis and/or a height based on a direction of travel of the film tube.
